(19) United States
(12) Patent Application Publication
(10) Pub. No.: US 2024/0401365 A1
(43) Pub. Date: Dec. 5, 2024

(54) Cavity Structure For Vehicle-Mounted Parasols

(71) Applicant: Guangzhouyiqiandao Technology Co., Ltd, Guangzhou (CN)

(72) Inventor: Xinxing Yi, Shaoyang (CN)

(21) Appl. No.: 18/501,405

(22) Filed: Nov. 3, 2023

(30) Foreign Application Priority Data
Jun. 2, 2023 (CN) 2023213940753

(51) Int. Cl. E04H 15/06

(52) U.S. Cl. CPC E04H 15/06

(57) ABSTRACT

Disclosed is a cavity structure for vehicle-mounted parasols, comprising a storage cavity, extension rod mechanisms, and an anti-theft rope mechanism; the storage cavity is respectively provided with a placement groove and a sliding groove, and the placement groove is connected to the sliding groove; the placement groove is provided with a fixedly connected iron sheet; the side cover comprises a side cover body, and the side cover body is provided with a No. 1 slot corresponding to the placement groove; the placement groove is provided with extension rod mechanisms symmetrically; both ends of the base are respectively located in the sliding groove, and the base can perform linear reciprocating motion along the extension direction of the sliding groove; the base is rotationally connected to the No. 1 connecting piece.

### 1. TECHNICAL FIELD

The invention related to the technical field of vehicle-mounted parasols, and in particular to a cavity structure for vehicle-mounted parasols.

### 2. BACKGROUND ART

At present, the number of cars is growing very rapidly. Every summer, the hot sunshine shines on the vehicles parked outdoors for a long time. Due to the high heat storage of the vehicle's metal shell, continuous high temperatures increase the internal temperature of the vehicle, which can even reach over 60° C. Car interior materials will continue to volatilize many harmful substances at such temperatures; even after the door is opened for ventilation, they will still be inhaled into the human body, causing damage to human health.

In addition, long-term exposure to the sun causes serious aging of materials inside and outside the vehicle, which not only increases the waste caused by replacing parts, but more seriously, it may cause the circuit inside the car to catch fire, causing the car to spontaneously ignite and causing a major accident.

In order to solve the problem of cars being exposed to the sun in the open air environment, a variety of vehicle-mounted sunshade devices have appeared on the market. However, every time a traditional parasol is used, it is relatively bulky and inconvenient to use and store, resulting in infrequent use. And the common parasol storage device is a rectangular box, which is stored by folding the parasol cloth, lacking a special storage cavity suitable for storing the parasol cloth through manual or automatic rotation.

In addition, there are still some problems with existing parasol devices: 1) at present, common parasols usually use rope fixation, suction cup fixation, etc. as a fixed base to fix the parasol on the roof of the car; however, the suction cups are usually common plastic suction cups, which have small suction power and are easy to fall off after long-term use; at the same time, existing fixed bases usually have a fixed-height structure and the height cannot be adjusted according to demands; 2) the parasol lacks the support of the supporting rod when it is unfolded, and its unfolded state or sunshade area is limited.

### 3. SUMMARY OF THE INVENTION

The technical problem to be solved by the invention is to overcome the defects of the above technology and provide a cavity structure for vehicle-mounted parasols.

In order to solve the above technical problems, the technical solutions provided by the invention are: a cavity structure for vehicle-mounted parasols, comprising a storage cavity, side covers, extension rod mechanisms, an anti-theft rope mechanism, an iron sheet, and supporting bases, wherein the storage cavity is provided with side covers on the left and right sides respectively; the storage cavity comprises a body, a placement groove, and a sliding groove; both sides of the bottom of the storage cavity are respectively provided with a No. 1 mounting hole and a No. 2 mounting hole; the storage cavity is respectively provided with storage cavities on the left and right sides; the body is respectively provided with a placement groove and a sliding groove, and the placement groove is connected to the sliding groove; the placement groove is provided with a fixedly connected iron sheet; the side cover comprises a side cover body, and the side cover body is provided with a No. 1 slot corresponding to the placement groove;

the placement groove is provided with extension rod mechanisms symmetrically; the extension rod mechanism comprises a base, a No. 1 connecting piece, a rod body, a clamping piece, and a rod head; both ends of the base are respectively located in the sliding groove, and the base can perform linear reciprocating motion along the extension direction of the sliding groove; the base is rotationally connected to the No. 1 connecting piece; the No. 1 connecting piece is fixedly connected to one end of the rod body, and the other end of the rod body is provided with a fixedly connected rod head; the rod body is provided with a fixedly connected clamping piece;

the anti-theft rope mechanism comprises a No. 1 braided belt, a No. 1 limiting piece, a tri-glide buckle, a stainless steel belt, a No. 2 braided belt, and a No. 2 limiting piece; one end of the No. 1 braided belt passes through a first buckle hole of the tri-glide buckle and is turned back and then passes through a second buckle hole, and the other end of the No. 1 braided belt is wrapped around the No. 1 limiting piece and folded; the No. 1 braided belt is sewn and connected to the edge of the folded part, and a cavity is formed between the two; the cavity is provided with a stainless steel belt; one end of the stainless steel belt is fixedly connected to the No. 1 limiting piece, and the other end of the stainless steel belt passes through the No. 2 mounting hole and is fixedly connected to the storage cavity through a fixing screw; the tri-glide buckle is provided with a No. 2 braided belt; the No. 2 braided belt passes through the No. 1 mounting hole, and forms a connection structure with the storage cavity through the No. 2 limiting piece connected to the end of the No. 2 braided belt.

Further, the storage cavity and the side covers are respectively provided with corresponding screw connection holes, and the storage cavity and the side covers form a connection structure through screws.

Further, the rod head is provided with a magnet.

Further, the No. 1 limiting piece is made of plastic material.

Further, the No. 1 slot is arranged correspondingly to the clamping piece; the No. 1 slot comprises an outer opening and an inner opening; the outer opening is arranged correspondingly with the clamping piece, and the inner opening is arranged correspondingly with the rod body.

Further, the left and right sides of the storage cavity are respectively provided with supporting bases for movable connection.

Further, the supporting base comprises an outer shell, an inner shell, a telescopic mechanism, a suction cup mechanism, and a connecting piece; the outer shell is a cavity structure with an opening at the bottom, and the inner shell is a cavity structure with an opening at the top; the inner shell forms a connection structure with the outer shell through the telescopic mechanism; the suction cup mechanism is provided at the bottom of the inner shell;

the outer shell comprises an outer shell body; the front side of the outer shell body is provided with a No. 2 slot and a plurality of positioning holes;

the inner shell comprises an inner shell body; the front side of the inner shell body is provided with a placement hole and through holes; the cavity of the inner shell body is provided with two connecting plates; the inner shell body and the connecting plates are an integrally formed structure; each connecting plate is provided with a inserting hole; the bottom of the inner shell body is provided with No. 3 mounting holes;

the telescopic mechanism comprises a No. 1 connecting rod, a pressing handle, supporting rods, and springs; the middle part of the No. 1 connecting rod is provided with a fixedly connected pressing handle, and the left and right ends of the No. 1 connecting rod are respectively provided with a supporting rod connecting piece; one end of each supporting rod connecting piece is provided with a supporting rod, and the other end of each supporting rod forms a connection structure with the connecting plates through the inserting holes; each supporting rod is provided with a spring; the other end of each supporting rod connecting piece passes through the through hole and the positioning hole respectively, so that the supporting rod connecting piece forms a connecting mechanism with the inner shell and the outer shell respectively;

the suction cup mechanism comprises a No. 2 connecting rod, suction cup connecting rods, a control handle, and suction cups; the middle part of the No. 2 connecting rod is provided with a fixedly connected control handle; the left and right ends of the No. 2 connecting rod are respectively provided with a C-shaped connection port; the No. 2 connecting rod and the suction cup connecting rod form a rotational connection structure through the C-shaped connection port; the suction cup connecting rod passes through the No. 3 mounting hole, and the end of the suction cup connecting rod and the suction cup form a connection structure.

Further, the top of the outer shell is provided with a fixedly connected No. 2 connecting piece.

Further, the spring is sleeved on the supporting rod, and both ends of the spring are respectively in contact with the No. 1 connecting rod and the connecting plate.

Further, the inserting hole comprises a No. 1 hole and a No. 2 hole, and the aperture of the No. 1 hole is larger than the aperture of the No. 2 hole.

The advantages of the invention compared with the prior art are: the device has a reasonable structural design and is easy to use; through the anti-theft rope mechanism, the parasol and the vehicle can form a connection structure to prevent the loss of the parasol; the extension rod mechanism can rotate and slide to meet the needs of unfolding or storing the parasol; at the same time, the mounting base is connected to the parasol body through a connecting piece; when it is necessary to adjust the height of the mounting base, apply force to the pressing handle to detach the outer shell from the inner shell, and then move the inner shell linearly along the setting direction of the outer shell; after the height is adjusted appropriately, release the pressing handle, and the supporting rod connecting piece will rebound to the positioning hole under the force of the spring, so that the outer shell and the inner shell form a connection structure again; in addition, the user can control the suction cup to be attached to the vehicle roof or detach from the vehicle roof by operating the control handle, which is easy to operate.

### 4. BRIEF DESCRIPTION OF ACCOMPANY DRAWINGS

FIG. 1 is a first schematic structural diagram of the cavity structure for vehicle-mounted parasols according to the invention;

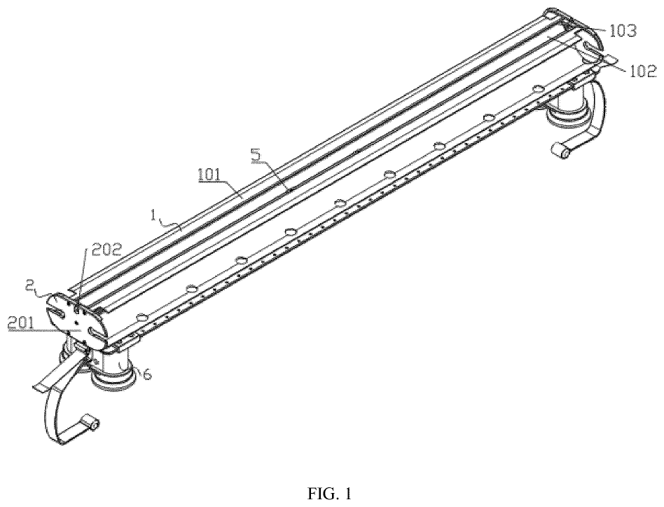

FIG. 2 is a first schematic diagram of the use of the extension rod in the cavity structure for vehicle-mounted parasols according to the invention;

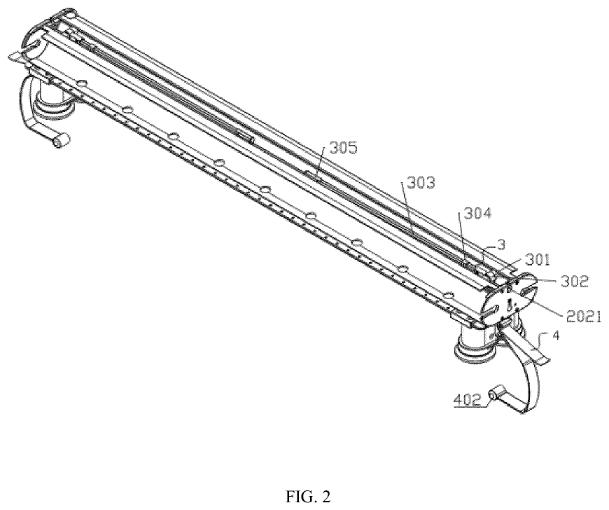

FIG. 3 is a second schematic diagram of the use of the extension rod in the cavity structure for vehicle-mounted parasols according to the invention;

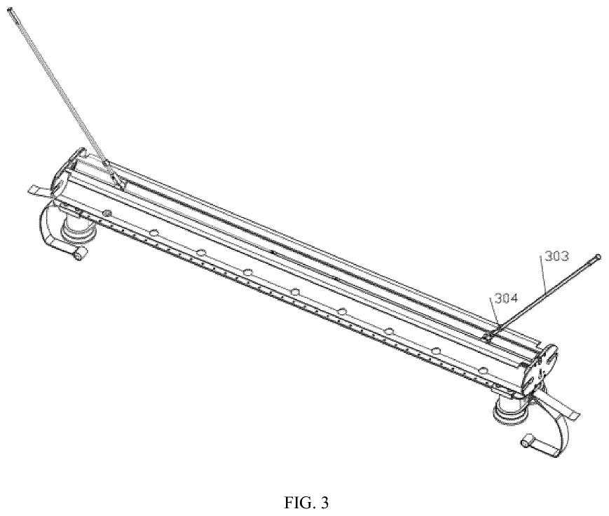

FIG. 4 is a third schematic diagram of the use of the extension rod in the cavity structure for vehicle-mounted parasols according to the invention;

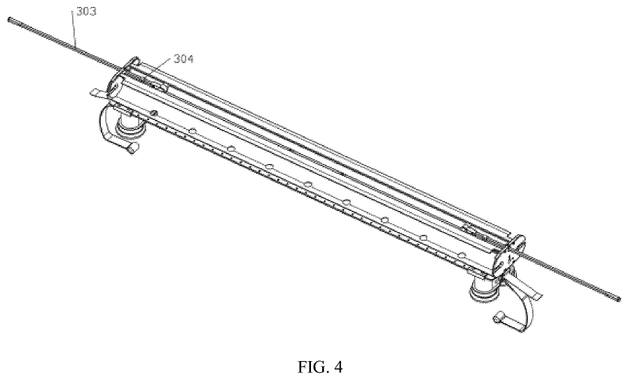

FIG. 5 is a fourth schematic diagram of the use of the extension rod in the cavity structure for vehicle-mounted parasols according to the invention;

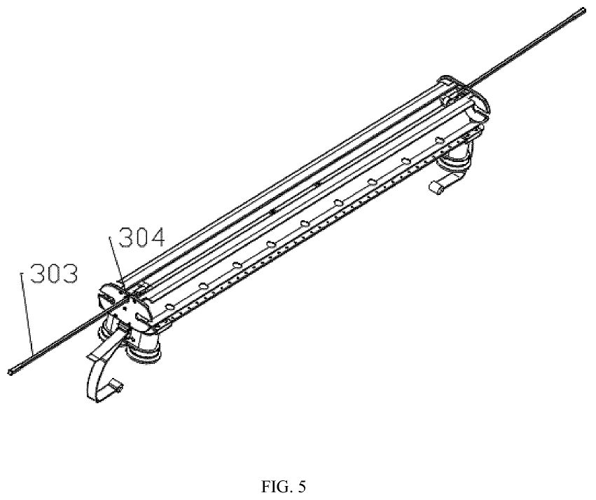

FIG. 6 is a schematic structural diagram of the storage cavity in the cavity structure for vehicle-mounted parasols according to the invention;

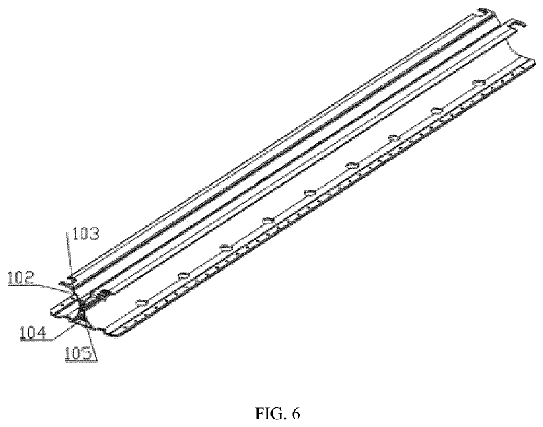

FIG. 7 is a partial structural schematic diagram of the for vehicle-mounted parasols according to the invention;

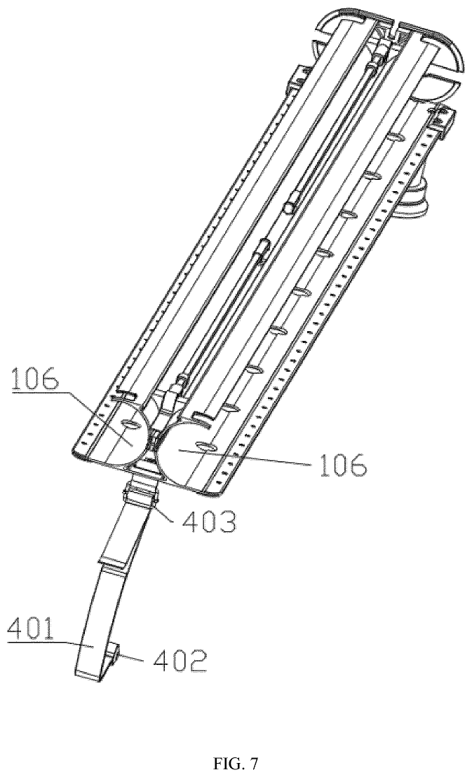

FIG. 8 is a cross-sectional view of the cavity structure in the cavity structure for vehicle-mounted parasols according to the invention;

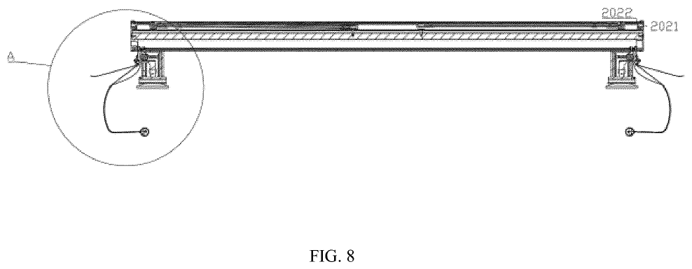

FIG. 9 is an enlarged view of part A in FIG. 8 of the cavity structure for vehicle-mounted parasols according to the invention;

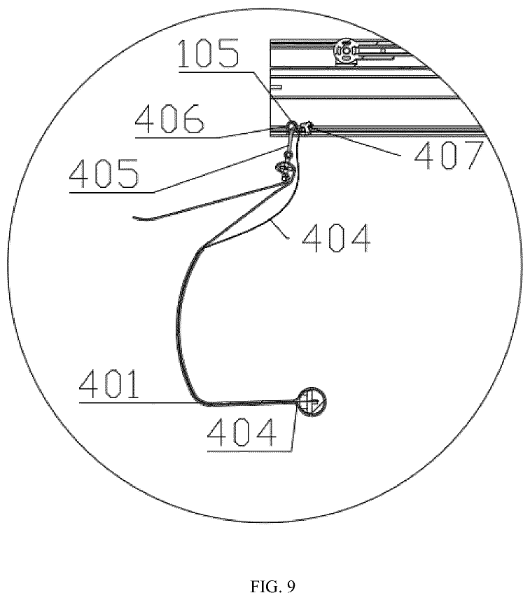

FIG. 10 is a schematic structural diagram of the tri-glide buckle used in the cavity structure for vehicle-mounted parasols according to the invention;

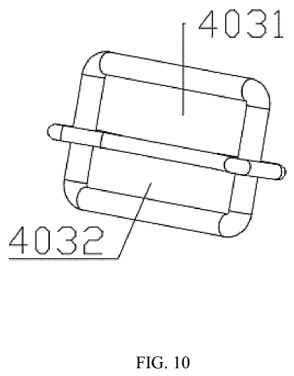

FIG. 11 is a schematic diagram of the use effect of the cavity structure for vehicle-mounted parasols according to the invention;

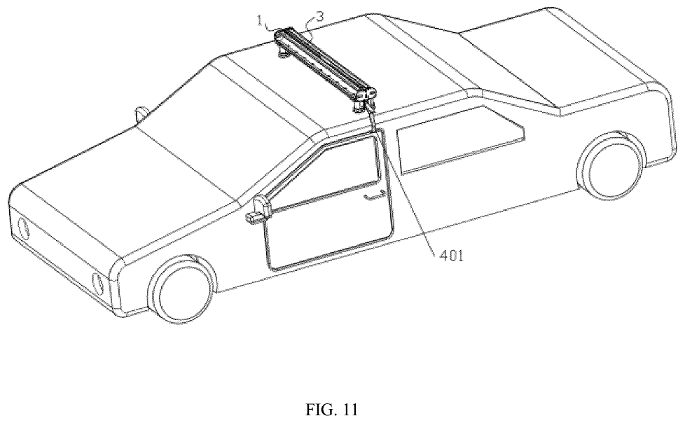

FIG. 12 is an exploded rendering of the supporting base in the cavity structure for vehicle-mounted parasols according to the invention;

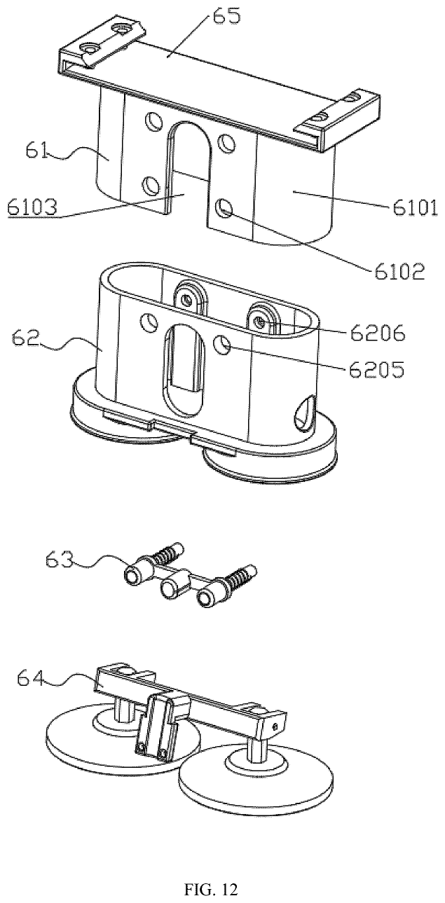

FIG. 13 is a first schematic structural diagram of the inner shell and telescopic mechanism in the cavity structure for vehicle-mounted parasols according to the invention;

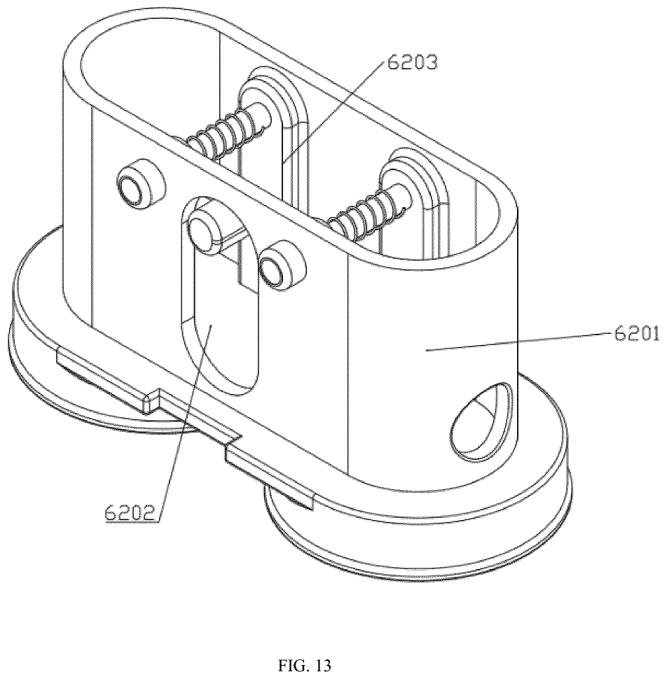

FIG. 14 is a second schematic structural diagram of the inner shell and telescopic mechanism in the cavity structure for vehicle-mounted parasols according to the invention;

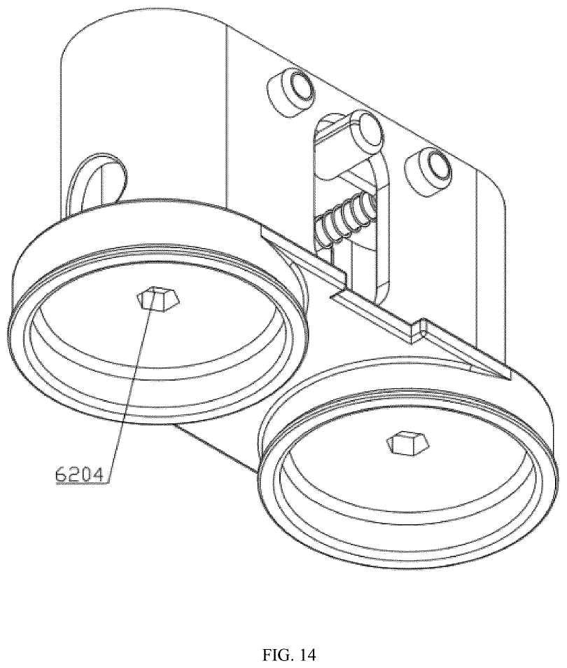

FIG. 15 is a schematic structural diagram of the telescopic mechanism used in the cavity structure for vehicle-mounted parasols according to the invention;

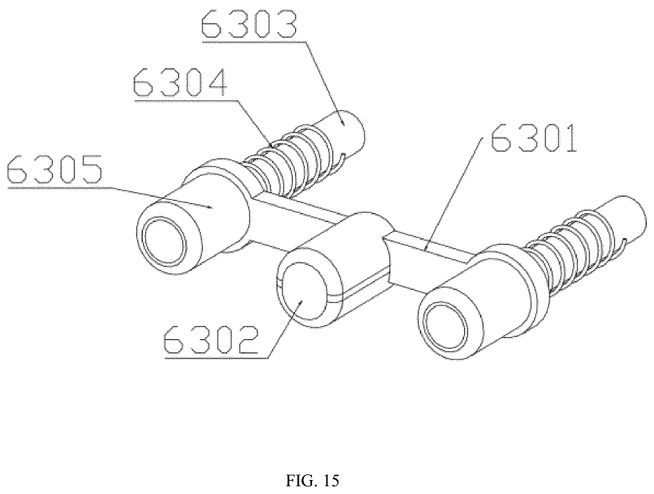

FIG. 16 is a schematic structural diagram of the suction cup mechanism used in the cavity structure for vehicle-mounted parasols according to the invention;

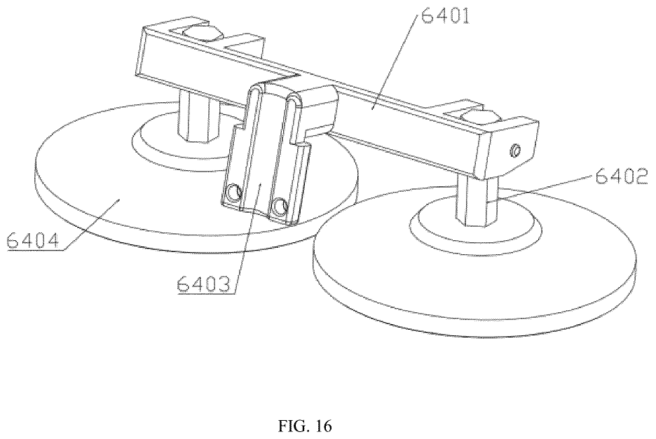

FIG. 17 is a schematic structural diagram of the supporting base used in the cavity structure for vehicle-mounted parasols according to the invention;

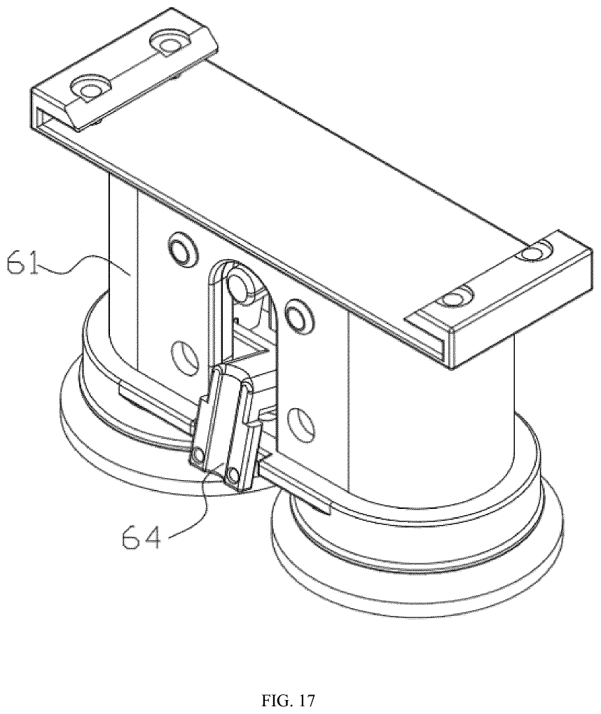

FIG. 18 is a first reference figure of the use state of the supporting base used in the cavity structure for vehicle-mounted parasols according to the invention;

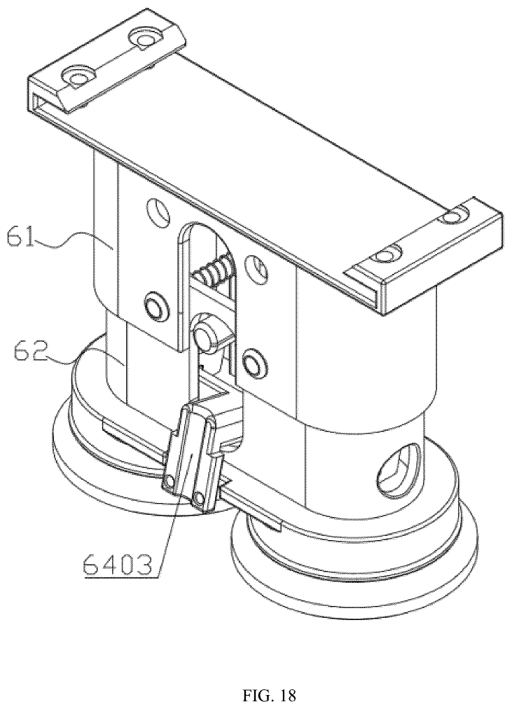

FIG. 19 is a second reference figure of the use state of the supporting base used in the cavity structure for vehicle-mounted parasols according to the invention;

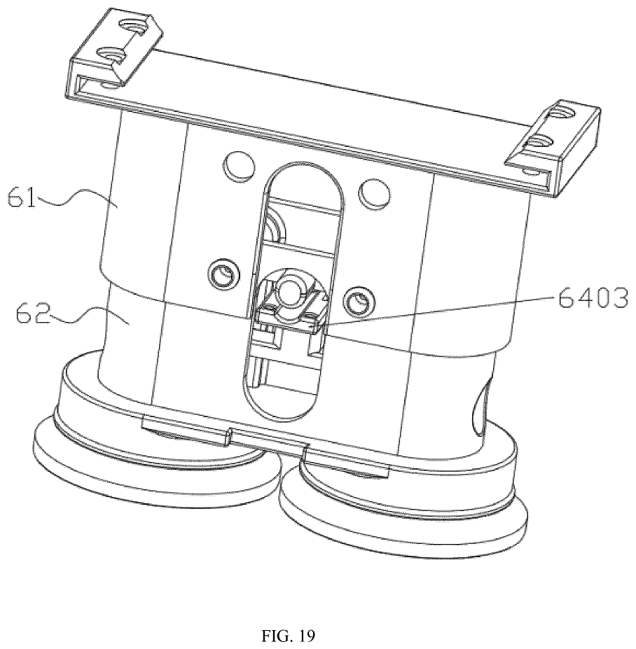

FIG. 20 is a schematic structural diagram of the inner shell used in the cavity structure for vehicle-mounted parasols according to the invention;

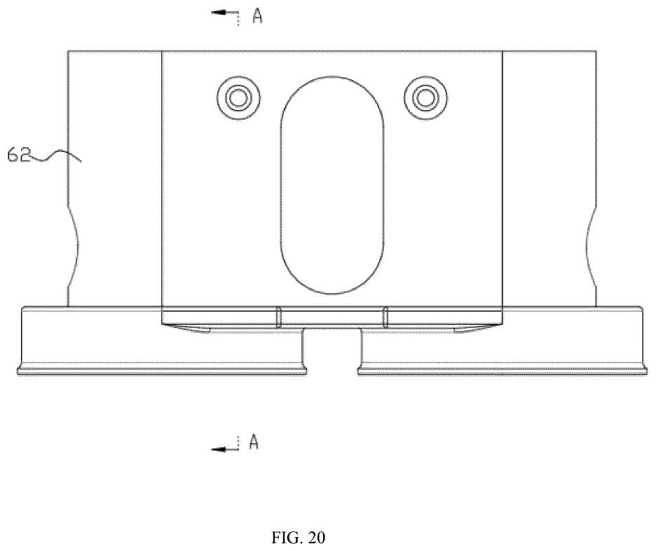

FIG. 21 is a cross-sectional view of the cavity structure for vehicle-mounted parasols according to the invention at A-A in FIG. 20.

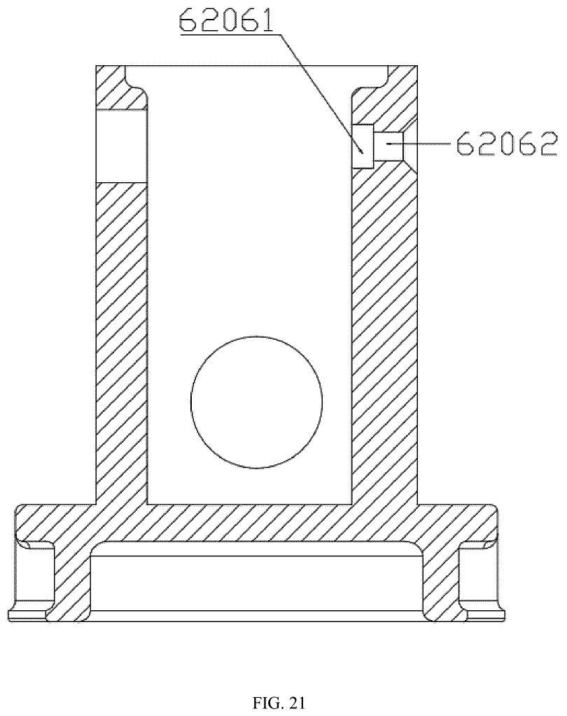

As shown in the figures, 1 refers to the storage cavity; 101 refers to the body; 102 refers to the placement groove; 103 refers to the sliding groove; 104 refers to the No. 1 mounting hole; 105 refers to the No. 2 mounting hole; 106 refers to the storage cavity; 2 refers to the side cover; 201 refers to the side cover body; 202 refers to the No. 1 slot; 2021 refers to the outer opening; 2022 refers to the inner opening; 3 refers to the extension rod mechanism; 301 refers to the base; 302 refers to the No. 1 connecting piece; 303 refers to the rod body; 304 refers to the clamping piece; 305 refers to the rod head; 4 refers to the anti-theft rope mechanism; 401 refers to the No. 1 braided belt; 402 refers to the No. 1 limiting piece; 403 refers to the tri-glide buckle; 4031 refers to the first buckle hole; 4032 refers to the second buckle hole; 404 refers to the stainless steel belt; 405 refers to the No. 2 braided belt; 406 refers to the No. 2 limiting piece; 407 refers to the fixing screw; 5 refers to the iron sheet; 6 refers to the supporting base; 61 refers to the outer shell; 6101 refers to the outer shell body; 6102 refers to the positioning hole; 6103 refers to the No. 2 slot; 62 refers to the inner shell; 6201 refers to the inner shell body; 6202 refers to the placement hole; 6203 refers to the connecting plate; 6204 refers to the No. 3 mounting hole; 6205 refers to the through hole; 6206 refers to the inserting hole; 62061 refers to the No. 1 hole; 62062 refers to the No. 2 hole; 63 refers to the telescopic mechanism; 6301 refers to the No. 1 connecting rod; 6302 refers to the pressing handle; 6303 refers to the supporting rod; 6304 refers to the spring; 6305 refers to the supporting rod connecting piece; 64 refers to the suction cup mechanism; 6401 refers to the No. 2 connecting rod; 6402 refers to the suction cup connection rod; 6403 refers to the control handle; 6404 refers to the suction cup; 65 refers to the No. 2 connecting piece.

### 5. SPECIFIC EMBODIMENT OF THE INVENTION

The cavity structure for vehicle-mounted parasols according to the invention will be described in further detail hereinafter with reference to the drawings.

With reference to the drawings, when the device is in use, storage cavities 106 for storing parasol cloths are provided on the left and right sides of the storage cavity 1; when the parasol cloth is pulled out from the front and rear chambers and the folded parasol cloth needs to be unfolded outward, the rod body 303 can rotate along the base 301 through the No. 1 connecting piece 302; at the same time, the base 301 is controlled to slide along the sliding groove 103 toward the middle direction of the storage cavity 1, so that the clamping piece 304 moves to the outside of the No. 1 slot 202, and moves the base 301; since the outer opening 2021 and the clamping piece 304 are arranged correspondingly, and the inner opening 2022 is arranged correspondingly to the rod body 303, so that the inner opening 2022 of the No. 1 slot 202 forms a limiting fixation on the clamping piece 304 to stabilize the rod body 303; then the parasol cloth can be connected to the rod body 303, thereby achieving support of the front and rear parasol cloths close to the cavity;

when the parasol cloth needs to be stored, first disconnect the parasol cloth from the rod body 303, and then reverse the above steps to roll the parasol cloth into the storage cavity 106, and at the same time reset the rod body 303; since the rod head 305 is provided with a magnet, when the rod body 303 is reset, the rod head 305 will attract the iron sheet 5, thereby fixing the rod body 303;

when using the anti-theft rope mechanism 4, first place one end of the No. 1 limiting piece 402 inside the car, and fix it inside the vehicle body through the vehicle door; one end of the stainless steel belt 404 is fixedly connected to the No. 1 limiting piece 402, and the other end of the stainless steel belt 404 passes through the No. 2 mounting hole 105 and is fixedly connected to the storage cavity 1; the tri-glide buckle 403 is provided with a No. 2 braided belt 405; the No. 2 braided belt 405 passes through the No. 1 mounting hole 104, and forms a connection structure with the storage cavity 1 through the No. 2 limiting piece 406 connected to the end of the No. 2 braided belt 405; one end of the No. 1 braided belt 401 passes through a first buckle hole 4031 of the tri-glide buckle 403 and is turned back and then passes through a second buckle hole 4032; by pulling the No. 1 braided belt 401, the No. 1 braided belt 401 can be tightened until the anti-theft rope mechanism 4 is tightened to a suitable tightness; since one end of the stainless steel belt 404 is fixedly connected to the No. 1 limiting piece 402, and the other end of the stainless steel belt 404 passes through the No. 2 mounting hole 105 and is fixedly connected to the storage cavity 1 through a fixing screw 407, a reliable connection between the vehicle body and the parasol device can be formed, which effectively prevents the accidental loss of the parasol device.

The left and right sides of the storage cavity 1 are respectively provided with supporting bases 6 for movable connection, and the specific usage operations of the supporting base 6 are:

when it needs to be installed on the top of the vehicle, the user can pull the control handle 6403 upward; under the transmission of the No. 2 connecting rod 6401 and the suction cup connecting rod 6402, the suction cup 6404 will form an adsorption state with the top of the vehicle;

when it needs to be removed from the top of the vehicle, the user can pull the control handle 6403 downward, and under the transmission of the No. 2 connecting rod 6401 and the suction cup connecting rod 6402, the suction cup 6404 will break away from the adsorption state of the top of the vehicle can be removed;

when it is necessary to adjust the height of the mounting base, the user can exert force on the pressing handle 6302 so that the support rod connecting piece 6305 is pressed inwardly; the spring 6304 will be compressed, causing the outer shell 61 and the inner shell 62 to disconnect; then move the inner shell 62 linearly along the direction of the outer shell 61; after the height is adjusted appropriately, release the pressing handle 6302, then the supporting rod connecting piece 6305 rebounds into the positioning hole 6102 of the corresponding height under the elastic force of the spring 6304, so that the outer shell 61 and the inner shell 62 form a connection structure again, thereby completing the adjustment of the height of the mounting base.

The invention and the embodiments thereof are described hereinabove, and this description is not restrictive. What is shown in the drawings is only one of the embodiments of the invention, and the actual structure is not limited thereto. All in all, structural methods and embodiments similar to the technical solution without deviating from the purpose of the invention made by those of ordinary skill in the art without creative design shall all fall within the protection scope of the invention.

1. A cavity structure for vehicle-mounted parasols, comprising a storage cavity (1), side covers (2), extension rod mechanisms (3), an anti-theft rope mechanism (4), an iron sheet (5), and supporting bases (6), wherein the storage cavity (1) is provided with side covers (2) on the left and right sides respectively; the storage cavity (1) comprises a body (101), a placement groove (102), and a sliding groove (103); both sides of the bottom of the storage cavity (1) are respectively provided with a No. 1 mounting hole (104) and a No. 2 mounting hole (105); the storage cavity (1) is respectively provided with storage cavities (106) on the left and right sides; the body (101) is respectively provided with a placement groove (102) and a sliding groove (103), and the placement groove (102) is connected to the sliding groove (103); the placement groove (102) is provided with a fixedly connected iron sheet (5); the side cover (2) comprises a side cover body (201), and the side cover body (201) is provided with a No. 1 slot (202) corresponding to the placement groove (102);
the placement groove (102) is provided with extension rod mechanisms (3) symmetrically; the extension rod mechanism (3) comprises a base (301), a No. 1 connecting piece (302), a rod body (303), a clamping piece (304), and a rod head (305); both ends of the base (301) are respectively located in the sliding groove (103), and the base (301) can perform linear reciprocating motion along the extension direction of the sliding groove (103); the base (301) is rotationally connected to the No. 1 connecting piece (302); the No. 1 connecting piece (302) is fixedly connected to one end of the rod body (303), and the other end of the rod body (303) is provided with a fixedly connected rod head (305); the rod body (303) is provided with a fixedly connected clamping piece (304);
the anti-theft rope mechanism (4) comprises a No. 1 braided belt (401), a No. 1 limiting piece (402), a tri-glide buckle (403), a stainless steel belt (404), a No. 2 braided belt (405), and a No. 2 limiting piece (406); one end of the No. 1 braided belt (401) passes through a first buckle hole (4031) of the tri-glide buckle (403) and is turned back and then passes through a second buckle hole (4032), and the other end of the No. 1 braided belt (401) is wrapped around the No. 1 limiting piece (402) and folded; the No. 1 braided belt (401) is sewn and connected to the edge of the folded part, and a cavity is formed between the two; the cavity is provided with a stainless steel belt (404); one end of the stainless steel belt (404) is fixedly connected to the No. 1 limiting piece (402), and the other end of the stainless steel belt (404) passes through the No. 2 mounting hole (105) and is fixedly connected to the storage cavity (1) through a fixing screw (407); the tri-glide buckle (403) is provided with a No. 2 braided belt (405); the No. 2 braided belt (405) passes through the No. 1 mounting hole (104), and forms a connection structure with the storage cavity (1) through the No. 2 limiting piece (406) connected to the end of the No. 2 braided belt (405).

2. The cavity structure for vehicle-mounted parasols according to claim 1, wherein the storage cavity (1) and the side covers (2) are respectively provided with corresponding screw connection holes, and the storage cavity (1) and the side covers (2) form a connection structure through screws.

3. The cavity structure for vehicle-mounted parasols according to claim 1, wherein the rod head (305) is provided with a magnet.

4. The cavity structure for vehicle-mounted parasols according to claim 1, wherein the No. 1 limiting piece (402) is made of plastic material.

5. The cavity structure for vehicle-mounted parasols according to claim 1, wherein the No. 1 slot (202) is arranged correspondingly to the clamping piece (304); the No. 1 slot (202) comprises an outer opening (2021) and an inner opening (2022); the outer opening (2021) is arranged correspondingly with the clamping piece (304), and the inner opening (2022) is arranged correspondingly with the rod body (303).

6. The cavity structure for vehicle-mounted parasols according to claim 1, wherein the left and right sides of the storage cavity (1) are respectively provided with supporting bases (6) for movable connection.

7. The cavity structure for vehicle-mounted parasols according to claim 6, wherein the supporting base (6) comprises an outer shell (61), an inner shell (62), a telescopic mechanism (63), a suction cup mechanism (64), and a connecting piece (65); the outer shell (61) is a cavity structure with an opening at the bottom, and the inner shell (62) is a cavity structure with an opening at the top; the inner shell (62) forms a connection structure with the outer shell (1) through the telescopic mechanism (3); the suction cup mechanism (64) is provided at the bottom of the inner shell (62);
the outer shell (61) comprises an outer shell body (6101); the front side of the outer shell body (6101) is provided with a No. 2 slot (6103) and a plurality of positioning holes (6102);
the inner shell (62) comprises an inner shell body (6201); the front side of the inner shell body (6201) is provided with a placement hole (6202) and through holes (6205); the cavity of the inner shell body (6201) is provided with two connecting plates (6203); the inner shell body (6201) and the connecting plates (6203) are an integrally formed structure; each connecting plate (6203) is provided with a inserting hole (6206); the bottom of the inner shell body (6201) is provided with No. 3 mounting holes (6204);
the telescopic mechanism (63) comprises a No. 1 connecting rod (6301), a pressing handle (6302), supporting rods (6303), and springs (6304); the middle part of the No. 1 connecting rod (6301) is provided with a fixedly connected pressing handle (6302), and the left and right ends of the No. 1 connecting rod (6301) are respectively provided with a supporting rod connecting piece (6305); one end of each supporting rod connecting piece (6305) is provided with a supporting rod (6303), and the other end of each supporting rod (6303) forms a connection structure with the connecting plates (6203) through the inserting holes (6206); each supporting rod (6303) is provided with a spring (6304); the other end of each supporting rod connecting piece (6305) passes through the through hole (6205) and the positioning hole (6102) respectively, so that the supporting rod connecting piece (6305) forms a connecting mechanism with the inner shell (62) and the outer shell (61) respectively;
the suction cup mechanism (64) comprises a No. 2 connecting rod (6401), suction cup connecting rods (6402), a control handle (6403), and suction cups (6404); the middle part of the No. 2 connecting rod (6401) is provided with a fixedly connected control handle (6403); the left and right ends of the No. 2 connecting rod (6401) are respectively provided with a C-shaped connection port; the No. 2 connecting rod (6401) and the suction cup connecting rod (6402) form a rotational connection structure through the C-shaped connection port; the suction cup connecting rod (6402) passes through the No. 3 mounting hole (6204), and the end of the suction cup connecting rod (6402) and the suction cup (404) form a connection structure.

8. The cavity structure for vehicle-mounted parasols according to claim 7, wherein the top of the outer shell (61) is provided with a fixedly connected No. 2 connecting piece (65).

9. The cavity structure for vehicle-mounted parasols according to claim 7, wherein the spring (6304) is sleeved on the supporting rod (6303), and both ends of the spring (6304) are respectively in contact with the No. 1 connecting rod (6301) and the connecting plate (6203).

10. The cavity structure for vehicle-mounted parasols according to claim 7, wherein the inserting hole (6206) comprises a No. 1 hole (62061) and a No. 2 hole (62062), and the aperture of the No. 1 hole (62061) is larger than the aperture of the No. 2 hole (62062).
